(19) United States
(12) Patent Application Publication
(10) Pub. No.: US 2004/0156988 A1
(43) Pub. Date: Aug. 12, 2004

(54) Selective and alignment-free molecular patterning of surfaces

(76) Inventors: Neville Z. Mehenti, East Windsor, NJ (US); Harvey A. Fishman, Menlo Park, CA (US); Stacey Francine Bent, Palo Alto, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/640,413

(22) Filed: Aug. 12, 2003

Related U.S. Application Data
(60) Provisional application No. 60/406,126, filed on Aug. 26, 2002.

(51) Int. Cl. B05D 5/00; B05C 1/00

(52) U.S. Cl. 427/256; 118/200

(57) ABSTRACT

The present invention is directed towards a method and means for molecularly patterning a surface to promote the patterned attachment of a target adherent. In some preferred embodiments the target adherent is a biological cell, but it can more generally be a biological or chemical species for which attachment at specific sites is desired. The method generally involves using a stamp to microcontact print a first type of molecule on the surface. With the stamp remaining in situ, the process then involves fluidic patterning of a second type of molecule through selected openings defined by selected recesses in the stamp and the surface itself. The second type of molecule should have an adhesion property relative to the target adherent that is complementary to that of the first type of molecule. The stamp is removed only after both the first and second types of molecules have been transferred to the surface.

### CROSS-REFERENCE TO RELATED APPLICATIONS

This application claims priorty under 35 U.S.C. 119(e) to U.S. provisional application 60/406126 filed Aug. 26, 2002, entitled Selective and Alignment-Free Molecular Patterning of Surfaces, the entire contents of which are hereby incorporated by reference.

### FIELD OF THE INVENTION

The present invention relates to the molecular patterning of a surface. In particular, it relates to patterning by combined use of microcontact printing and fluidic patterning using a single stamp without complicated alignment techniques.

### BACKGROUND OF THE INVENTION

Numerous applications in the development of biological as well as non-biological diagnostic and sensory devices require the selective patterning of different molecules on surfaces. Examples are, for instance, but not limited to, chemical diagnostic devices, fabrication of biological analytical systems that use cells or proteins as sensors, neural prostheses/interfaces, artificial tissue, DNA probes/sensor or protein chips, and combinatorial screening strategies. The spatial control of cell adhesion and growth not only allows such applications to be carried out in parallel, but also can be used to answer basic science questions through the investigation of cell and protein function. This ability also enables the formation of neural networks to investigate nerve cell function.

Current approaches for patterning biomolecules or proteins on surfaces include, for instance, microcontact printing and fluidic patterning by flowing a fluid through microfluidic networks.

In microcontact printing, the molecule of interest is “inked” onto a stamp, which is typically a soft polymer with a relief structure. Such stamps are usually formed by casting the polymer on a microfabricated mold. The inked stamp is then stamped onto the surface, transferring the molecule of interest to the surface.

U.S. Pat. No. 5,512,131 by Kumar et al provides an exemplary teaching of microcontact printing. Kumar et al disclose a method of patterning a surface by using a stamp to transfer one or more chemical species from the raised regions of the stamp to the material surface. The patent provides detailed disclosures as to procedures useful for forming and using suitable stamps. To lay down multiple species on the surface, Kumar at al teaches the use of multiple stampings. Note that to achieve high resolution, the stamps be carefully aligned to ensure that each subsequent patterning is placed in appropriate relationship with the previous patternings.

A somewhat different microcontact printing process for transferring different molecular species to a surface is disclosed by Turner, Martin, and Gaber in U.S. Pat. No. 5,948,621. They teach the use of a macromolecular stamp made using a polymeric gel. One surface of the polymeric gel is bound to a solid substrate. Another surface of the polymeric gel is exposed and is patterned to include raised regions and indented regions. The raised regions include the polymeric gel, while the indented regions may or may not include the polymeric gel. The polymeric gel acts as a sponge for a solutions or suspension of a molecular species. The raised regions of the patterned surface are immersed within one or more reservoirs for a solution or suspension of a molecular species. If desired, several reservoirs, each containing a unique molecular species, may be used to form an array of multiple molecular species. After the polymeric gel on the patterned surface has absorbed the molecular species from the reservoir(s), the patterned surface is pressed against a solid surface, thereby transferring the absorbed molecular species to that solid surface in a pattern corresponding to that of the patterned surface.

Fluidic patterning is a fundamentally different process for transferring molecules to a surface. In fluidic patterning, a material with a relief structure is placed in conformal contact with the surface and the molecule of interest is flowed in solution through microchannels defined by the relief structure. The molecule of interest is deposited on the surface inside the microchannels through physical or chemical interactions.

In U.S. patent Publication No. 2002/0050220, Schueller et al teach the use of a stamp for microcontact printing, and fluidic patterning. With respect to the fluidic patterning, they teach that a stamp having a continuous pattern of channels is placed against the surface. The channels are connected to a fluid source from which fluid can pass through the channels and exit the stamp at a second location. The fluid may enter and exit the channels via tubing. The raised portions of the stamp confine the fluid to a path along the surface defined by the channels. Additionally, they indicate that a surface may be patterned via stamping or fluidic patterning, or both. The stamp may deposit one material via contact printing and provide a path for fluidic patterning simultaneously.

Bernard et al (Bernard, Renault, Michel, Bosshard, and Delamarche, “Microcontact Printing of Proteins,” Adv. Mater. 12, (14), Jul. 19, 2000), teach that proteins adsorb preferentially to some surfaces but are repelled from others, therefore tailoring the surface properties offers the interesting capability of depositing proteins from solution in patterns. In particular, Bernard et al note that a gold surface can be patterned by self-assembling molecules (SAMs). In practice, they note that microcontact printing of a pattern of hydrophobic alkanethiols generates sites where proteins will deposit from solution after blocking the unprinted parts of the gold substrate with thiolated polyethylene glycol (PEGs) adsorbed from solution. Later in the article they note that it is common practice in immunoassays to use bovine serum albumin or other proteins to block all sites left available on a surface after immobilizing the desired proteins.

As a generalization of this approach, a surface can be patterned with both adhesion promoting molecules and adhesion inhibitory molecules. An adhesion promoting molecule promotes the attachment of cells to the molecule. Conversely, an adhesion inhibitory molecule inhibits the attachment of cells to the molecule. If a surface is patterned with an adhesion promoting molecule, and the surface is seeded with cells, the cells will preferentially attach to the adhesion promoting molecules on the surface. If an adhesion inhibitory molecule is patterned on the surface, then the cells that are seeded will prefer to attach to all parts of the surface where the molecule is not patterned. Improved selectivity can be achieved by covering the surface with adhesion promoting molecules where cell attachment is desired and with adhesion inhibitory molecules where cell attachment is not desired. The use of adhesion and inhibitory molecules can be extended to not only pattern cells, but also selectively attach other molecules for use in sensor or probe applications.

The patterning of a surface with both adhesion promoting and adhesion inhibitory molecules as described by Bernard et al is achieved through a variety of means. For instance, microcontact printing can be used with two complementary stamps, each stamp inked with molecules having a complementary adhesion property. This approach would require accurate alignment of the second stamp so that its molecules contact the surface only in those regions left vacant by the first stamp. Alternatively, as discussed in Bernard et al, a surface can be coated with one type of molecule and a stamp used to first lift off molecules in regions where they were not desired and then inking the stamp (or a separate stamp) with the desired molecules and stamping it again. This approach also requires that the second stamping be accurately aligned with the first stamping.

Yet another approach is to use microcontact printing to transfer a first type of molecule to the surface and then simply expose the surface to the complementary type of molecule. This approach has the advantage of simplicity, but it permits the second molecule to bind to any unoccupied sites within the patterned area of the first molecule. This would of course be detrimental, since the two types of molecules would now be more mixed than anticipated and the inhibitory properties of one molecule may more than offset the adhesion promoting capability of the other molecule.

In all of these approaches for laying down molecules with complementary adhesion properties, errors in the processes that lead to the aberrant bonding a one molecule in an area reserved for the complementary molecule can go largely unnoticed. The reason for reduced yields or other suboptimal performance of the product can easily be misidentified. Therefore an unappreciated need in this field is to develop a process whereby the molecules with complementary adhesion properties are transferred to the surface in precise locations, with no or very limited possibilities for molecules with the wrong adhesion property to be misplaced on the surface.

### SUMMARY OF THE INVENTION

Embodiments of the present invention provide novel methods and means for the patterning of molecules with complementary adhesion properties on a surface. In preferred embodiments, molecules with complementary adhesion properties (either adhesion promoting or adhesion inhibitory relative to a target adherent) are patterned on a surface without the use of complicated and expensive alignment techniques. In preferred embodiments, no, or very limited mixing of the molecules with complementary adhesion properties occurs. A general embodiment of the invention involves the following steps:

1. A stamp with raised and recessed portions is inked with a first type of molecule.

2. The stamp, inked with the first type of molecule is then placed on a surface to transfer the first type of molecule to the surface in a pattern defined by the raised portions of the stamp.

3. After the pattern with the first type of molecule is transferred on the surface or substrate, the stamp remains on the surface.

4. Optionally, a cleaning solution is flowed through selected openings defined by the surface, selected recessed portions of the stamp and the lateral sides of the raised portions of the stamp. In preferred embodiments, these openings are narrow and can be thought of as microchannels formed between the stamp and the surface. The cleaning solution rinses away any of the first type of molecule that is present in the selected openings as a result of either the inking or the stamping process, or both.

5. A second type of molecules is then flowed through the selected openings. The second type of molecule has an adhesion property that is complementary to that of the first type of molecule. In some embodiments, all the openings are selected and the second type of molecule is confined in space to every point on the surface not stamped by the raised portions of the stamp.

6. The stamp can then be removed to yield a surface that has been selectively patterned with the first type molecule and second type of molecule. In preferred embodiments, these two types of molecules are perfectly aligned in a monolayer.

Another aspect of the invention provides a surface patterner for applying to a surface an adhesion inhibitory type of molecule adjacent to an adhesion promoting type of molecule in a manner consistent with the process steps disclosed above. The surface patterner comprises a stamp having raised and recessed portions. The surface patterner also has a means for flowing a second type of molecule through selected openings without realigning the stamp. The second type of molecule should have an adhesion property complementary to that of the first type of molecule.

Some advantages of various embodiments of the present invention are:

The elimination of the need for multiple alignments.

The ensuring of minimal contamination of one type of molecule where the other type belongs.

Providing the possibility of a high throughput.

Low cost, in particular compared to methods using expensive alignment devices.

Employment of commonly available materials.

Additional features and advantages of the invention will be set forth in part in the description that follows, and in part will be obvious from the description, or may be learned by practice of the invention. Various embodiments of the invention do not necessarily include all of the stated features or achieve all of the stated advantages.

### BRIEF DESCRIPTION OF THE DRAWINGS

The accompanying drawings illustrate an embodiment of the invention according to the best modes so far devised for the practical application of the principles thereof, and in which:

FIGS. 1A-B show two views of a stamp with raised and recessed portions. FIG. 1A shows the side view corresponding to the cut A-A indicated in FIG. 1B. FIG. 1B shows the view from the bottom of the stamp.

FIG. 2 shows a stamp inked with a first type of molecule.

FIG. 3 shows a stamp transferring a first type of molecule to a surface to be patterned.

FIGS. 4A-B show two views of a cleaning solution flowing through selected openings. FIG. 4A shows a side view. FIG. 4B shows the view indicated in cut B-B of FIG. 4A.

FIGS. 5A-B show two views of a second type of molecule flowing through selected openings. FIG. 5A shows a side view. FIG. 5B shows the view indicated in cut B-B of FIG. 5A.

FIGS. 6A-B show two views of the patterned surface with the stamp removed. FIG. 6A shows a side view. FIG. 6B shows the view indicated in cut B-B of FIG. 6A.

FIG. 7A shows the target adherent attached to the second type of molecule. FIG. 7B shows the target adherent attached to the first type of molecule.

### DETAILED DESCRIPTION OF PREFERRED EMBODIMENTS

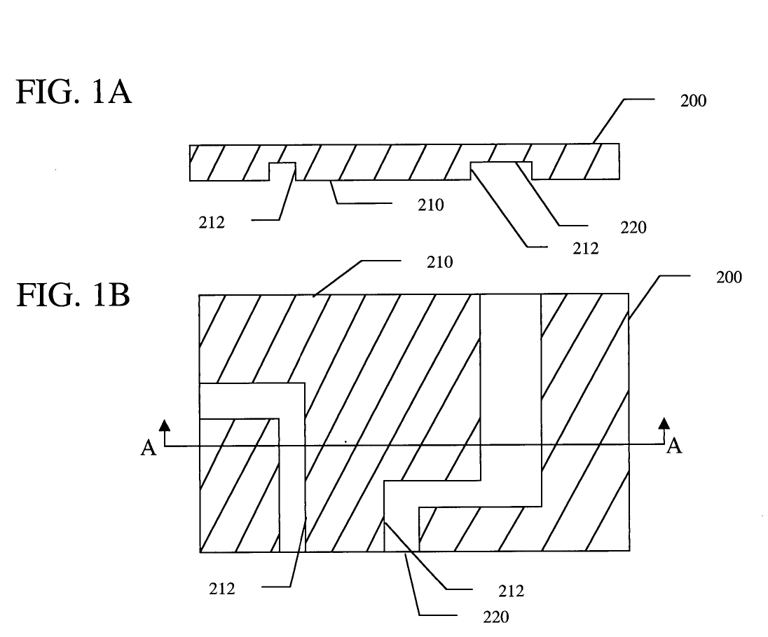

Referring now to the figures, where similar elements are numbered the same, FIGS. 1A-B show side and bottom views of a stamp 200. The side view indicated in FIG. 1A represents the view from the cut A-A indicated in FIG. 1B. The stamp 200 has raised portions 210 and recessed portions 220. The raised portions 210 have lateral sides 212. To avoid cluttering the figures, not all of the raised portions 210, lateral sides 212, and recessed portions 220 have been labeled. Stamps used in practice may be more or less complex than the stamp 200, which should be understood as being chosen for illustrative purposes only. The stamp 200 is shown with raised 210 and recessed 220 portions having variable shapes and sizes. The recessed portions 220 may be interconnected, or as shown here, independent.

The invention does not require the stamp to be made of any particular material or to be fashioned in any particular manner. A variety of suitable materials for the stamp 200 and methods for making the stamp 200 are known to those skilled in the art. Exemplary, but not restrictive examples are discussed in U.S. Pat. No. 5,512,131 to Kumar and Whitesides and U.S. patent Publication 2002/0050220 by Schueller, Kim, and Whitesides, both of which are incorporated by reference herein in their entireties. In brief, in one set of embodiments, the stamp 200 is formed by casting an elastomeric material about a master. The recessed portions 220 of the stamp 200 correspond to raised portions of the master, and the raised portions 210 of the stamp 200 correspond to recessed portions in the master. Following casting, the stamp 200 is removed from the master. A variety of techniques may be used to facilitate removal of the stamp 200 from the master. For instance, the stamp 200 may be swelled with a solvent. Alternatively, the master can be dissolved or melted, thereby freeing the stamp 200. In other alternatives, the master may be coated with a non-stick material such as poly(tetrafluoroethane) (PTFE) prior to casting of the stamp 200. Those skilled in the art will know of other procedures for forming the stamp 200.

The stamp may be formed from a large variety of materials. Preferably, the stamp 200 is formed from an elastomer, for example, poly(butadiene), poly(dimethylsiloxane) (PDMS), poly (acrylamide), poly(butylstyrene), polymerized chlorosilanes such as methylchlorosilanes, ethylchlorosilanes, and phenylchlorosilanes, and random or block co-polymers of these elastomers. Epoxy polymers, characterized by a three-member cyclic ether group commonly referred to as an epoxy group, 1,2-epoxide, or oxirane, may also be used to form the stamp 200. For example, diglycidyl ethers of bisphenol A or compounds based on aromatic amine, triazine, or cycloaliphatic backbones may be used as well. The stamp 200 may be formed of combinations of materials.

Alternatively, the stamp 200 itself may be fabricated from a polymer gel as disclosed by U.S. Pat. No. 5,948,621, the entire contents of which are incorporated herein by reference. In certain preferred embodiments, polymer gels having pore sizes of about 5 to about 200 nm enable the material to be stamped to flow within the gel. It will be appreciated that the gel composition may be adapted to the chemical properties of the stamped material. For example, hydrogels such as those based on acrylic acids esterified to a sugar and cross-linked polyacrylamides may be used to stamp hydrophilic molecules. Furthermore, polymers and liquid carriers may be chosen to stamp macromolecules such polymers and proteins onto a surface.

The stamp 200 will be used to facilitate the patterning of a surface to promote the patterned attachment of a target adherent. The target adherent preferably comprises biological cells, although in alternate embodiments, the target adherent comprises molecules or groups of molecules, either biological or nonbiological. The patterned attachment of the target adherent is achieved by patterning the surface with molecules that promote the attachment of the target adherent and molecules that inhibit the attachment of the target adherent. Those types of molecules that promote the attachment of the targeted adherent will be considered adhesion promoting types of molecules. In many embodiments, various proteins are used to promote adhesion of the target adherent. Some non-restrictive examples of adhesion promoting types of molecules that have been found useful for promoting the adhesion of biological cells are poly-D-lysine, laminin (which supports neurite outgrowth from nerve cells), and fibronectin. The types of molecules that inhibit the attachment of the target adherent will be considered adhesion inhibitory types of molecules. For target adherents of biological cells, some nonrestrictive examples of adhesion inhibitory types of molecules are: polyvinyl alcohol, polyethylene glycol, and bovine serum albumin (BSA). Clearly, the adhesion inhibitory types of molecules have an adhesion property that is complementary to that of the adhesion promoting types of molecules. The combined use of both types of molecules provides increased selectivity, which is often desirable.

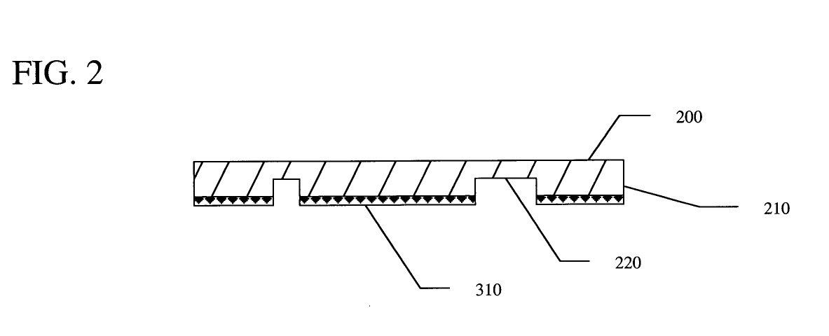

Referring now to FIG. 2, the raised portions 210 of the stamp 200 are inked with a first type of molecule 310. The first type of molecule 310, indicated with the diamond pattern in the figures, should have an adhesion property that is either adhesion promoting or adhesion inhibiting relative to the target adherent. Throughout this document, references to the first type of molecule 310, and later a second type of molecule should be understood to refer to either the molecules themselves or a solution or suspension containing the molecules. References herein to a solution of either type of molecule should be understood to imply a solution (in which the molecules are actually dissolved) or a suspension (in which the molecules are not dissolved). In addition, although the raised portions 210 are referred to in the plural herein, a stamp 200 having only a single raised portion 200 may be used, and references herein to raised portions 210 should be understood to refer to the single raised portion 210.

In the most preferred embodiments of the invention, the hydrophilicity of the stamp 200 is increased prior to the inking. This is most preferably accomplished by placing the stamp 200 in an oxygen plasma. The increased hydrophilicity enhances the spreading of a solution of the first type of molecule over the entire stamp.

The preferred mode of inking the stamp 200 allows a solution of the first type of molecule to absorb into the stamp for approximately half an hour. Other modes of inking the stamp 200 may also be used. Although not shown in FIG. 2, the inking process may result in the first type of molecule being spread to the lateral sides of the raised portions 210 of the stamp 200 as well as the recessed portions 220. This spreading is not typically a problem because only a very thin layer of molecules typically forms on the stamp, preferably only a single molecule thick. Substantially only the molecules on the raised portion 210 of the stamp 200 are ultimately transferred to the surface.

After inking the stamp 200 with the first type of molecule, the stamp is preferably dried. In various embodiments the drying is done under vacuum, by blowing nitrogen, or by simply letting the stamp sit in air. However, as indicated by Bernard et al (Bernard, Renault, Michel, Bosshard, and Delamarche, “Microcontact Printing of Proteins,” Adv. Mater. 12, (14), Jul. 19, 2000), in preferred embodiments the drying of the stamp should not be excessive, as the transfer of the molecules can decrease significantly if the stamp dries for much more than 1 minute in a 55% ambient humidity atmosphere. The drying process can have a profound change in the conformation of the molecules, thereby adversely affecting adhesion properties. The details of the drying process will vary with different embodiments, depending upon a variety of factors that may include the nature of the first type of molecule, the nature of the stamp, the nature of the surface, and perhaps other factors.

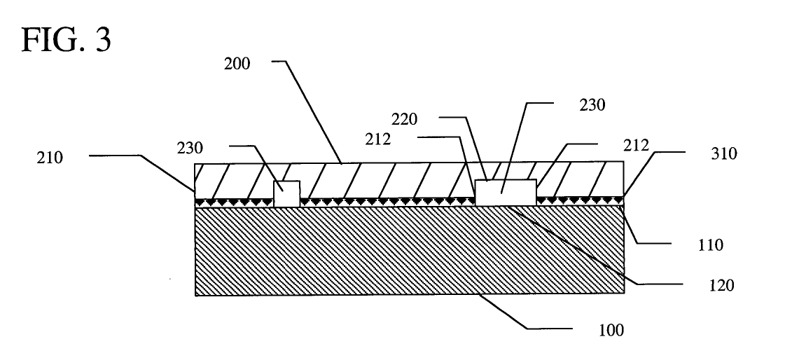

As shown in FIG. 3, a surface 110 is stamped with the stamp 200. In the illustrated embodiment, the surface 110 is the exposed part of a substrate 100. In many preferred embodiments, the substrate 100 is a glass or a plastic and in preferred embodiments, the surface 110 is just the exposed surface of the glass or plastic. However, many different materials may be used for the substrate 100 and the surface 110 may be of a separate material than the substrate 100. For instance an alternate embodiment may include a thin layer of gold deposited on a substrate 100. The surface 110 to be patterned would then be of a different material than the underlying substrate 100.

In the preferred embodiments a pressure of approximately 1000 Pa is substantially uniformly applied to the stamp 200 for approximately 5 minutes to facilitate the transfer of the first type of molecule 310 from the stamp 200 to the surface 110. During this process, the stamp 200 is typically considered to be in contact with the surface 110, even though a layer of the first type of molecule 310 actually separates the stamp 200 from the surface 110.

As seen in FIG. 3, openings 230 are defined by the surface 110, lateral sides 212 of the raised portions 210, and recessed portions 220 of the stamp 200. The transfer of the first type of molecule 310 from the stamp 200 to the surface 110 may result in some spreading of the first type of molecule 310 onto the portion of the surface 120 that helps define an opening 230. Such spreading is generally undesirable. It is often attributable to migration of molecules that do not bind to the surface. It is especially likely to occur in regions where the portions of the surface 120 that define the openings 230 have at least one dimension that is small.

In some embodiments, for selected openings 230, defined by selected portions of the surface 120, selected recessed portions 220 of the stamp 200, and selected lateral sides 212 of the raised portions 210 of the stamp 200, an estimate is made of the amount of spreading of the first type of molecule 310 to the selected portion of the surface 120. If the estimated amount of spreading exceeds an allowable tolerance, a cleaning solution is flowed through the selected openings 230. The estimation of the amount of spreading may be accomplished by determining the smallest distance associated with any selected portion of the surface 120. This smallest distance corresponds to the smallest distance between lateral sides 212 that bound the selected portion of the surface 120. In some embodiments, if this smallest distance is less than 20 microns, then the amount of spreading of the first type of molecule 310 is estimated to exceed the allowable tolerance. Note that not all openings 230 need to be considered, only selected openings 230. This gives the user the option of choosing some openings 230 to be more carefully controlled than others. In most preferred embodiments, all openings 230 will be selected.

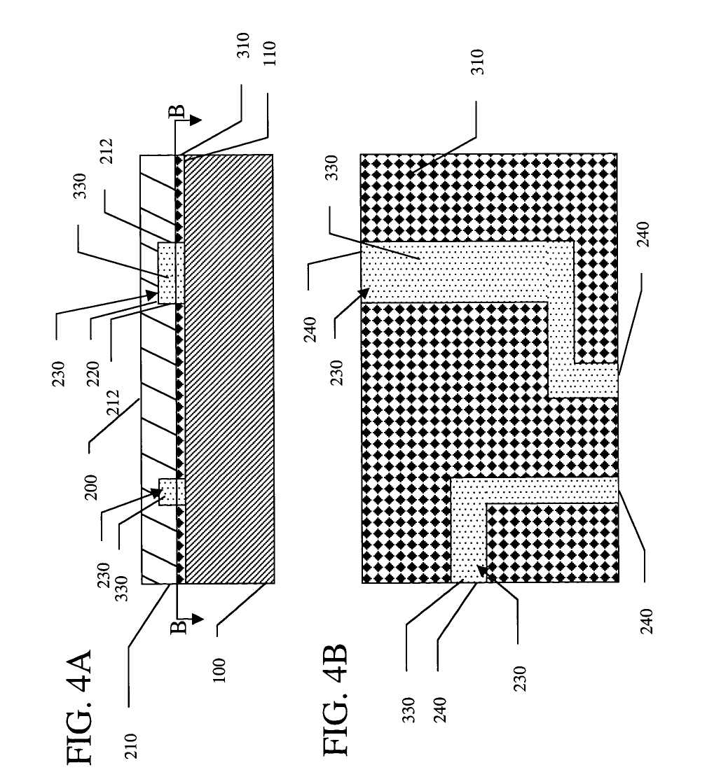

FIGS. 4A-B show a cleaning solution being flowed through the selected openings 230. FIG. 4A is the side view; FIG. 4B shows a view looking towards the surface 110 through the cut B-B indicated in FIG. 4A. The cleaning solution 330 is indicated by the dotted pattern in the figures. The cleaning solution is preferably water, although other cleaning solutions may be used in alternate embodiments. In preferred embodiments, as indicated in FIGS. 4A-B, each selected opening 230 has at least two ports 240. Two ports 240 allow for the cleaning solution 330 to enter through one port 240 and exit via the other port 240. In alternate embodiments, the absence of two ports 240, the cleaning solution 330 can be injected and removed through a single port 240. Alternate embodiments (not shown) may also include one or more ports that enter and/or exit the selected opening through the top of the stamp.

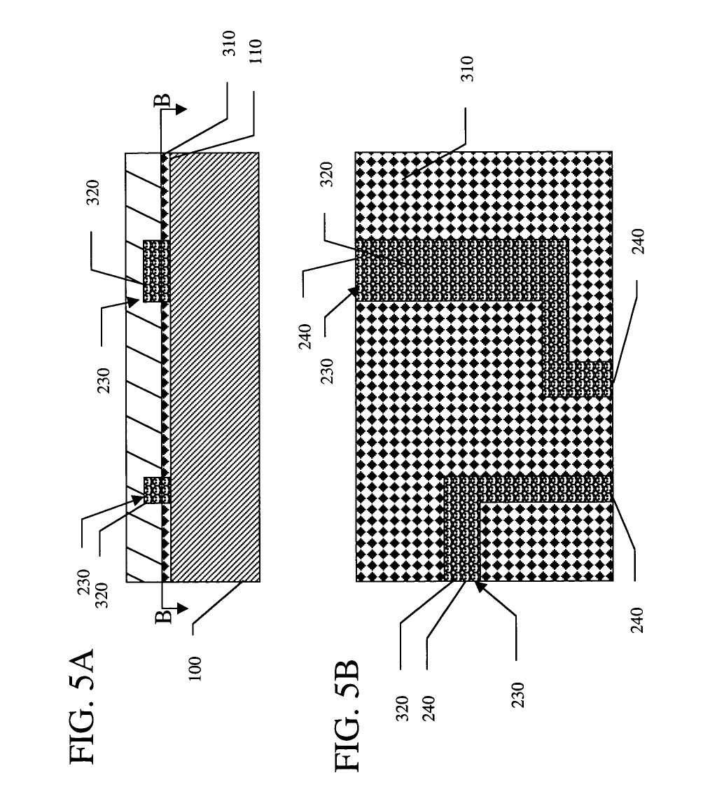

In FIGS. 5A-B, a second type of molecule 320 is flowed through the selected openings 230. The second type of molecule 320 has an adhesion property that is complementary to that of the first type of molecule 310. For instance, if the first type of molecule 310 is an adhesion inhibitory type of molecule, then the second type of molecule 320 should be an adhesion promoting type of molecule. Conversely, if the first type of molecule 310 is an adhesion promoting type of molecule, then the second type of molecule 320 should be an adhesion inhibitory type of molecule. The same issues regarding the ports 240 that applied in the case of flowing the cleaning solution through the selected openings 230 apply to the flowing of the second type of molecule 320 through the selected openings 230.

In general it is preferable that the type of molecule in the more viscous solution be the first type of molecule 310 and the molecule in the less viscous solution be the second type of molecule 320. This preference facilitates the flowing of the second type of molecule through the selected openings 230. However, in many embodiments, both solutions comprise low concentrations of proteins and are insufficiently viscous for the viscosity of the solution to be important in determining which molecule is flowed through the selected openings 230. Especially if the hydrophilicity of the stamp 200 has been increased, for instance by exposing it to an oxygen plasma, capillary action in the selected openings 230 often does a good job of pulling the solution through the selected openings 230. If the capillary action is insufficient, the solution can be flowed through the selected openings 230 by applying a positive pressure to the solution entering the selected openings 230, a negative pressure to the solution exiting the selected openings 230, or some combination thereof. In preferred embodiments, the second type of molecule 320 is permitted to adsorb for 5-10 minutes after being flowed through the selected openings 230. After adsorbing, in preferred embodiments, a second cleaning solution is flowed through the selected openings. The second cleaning solution is preferably water, and its purpose is to wash out any unbound molecule of the second type of molecule 320 that has not bounded to the surface 110. This helps to avoid any unbound molecules from later binding to undesired areas after the stamp 200 is removed. Preferably, the surface 100 is then dried with the stamp 200 still in place. In some embodiments the drying is done under vacuum, preferably in a desiccator. In other embodiments, the drying is done by blowing nitrogen. In still other embodiments the drying is done in ambient air.

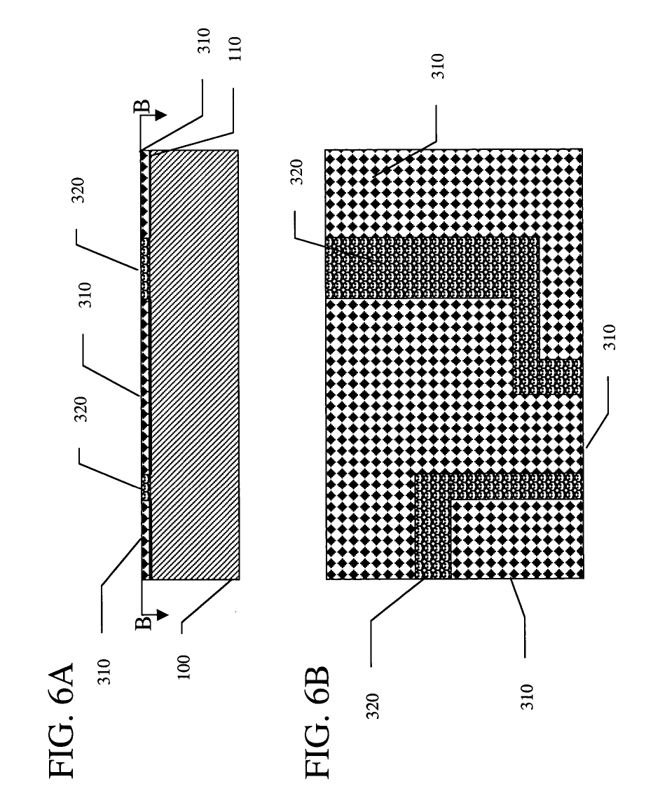

As shown in FIGS. 6A-B, the stamp is removed and the surface 110 is covered with both the first type of molecule 310 and the second type of molecule 320. Sharp boundaries between the different types of molecules can be obtained with this approach. In preferred embodiments of the invention, the first type of molecule 310 and the second type of molecule 320 are perfectly aligned in a monolayer.

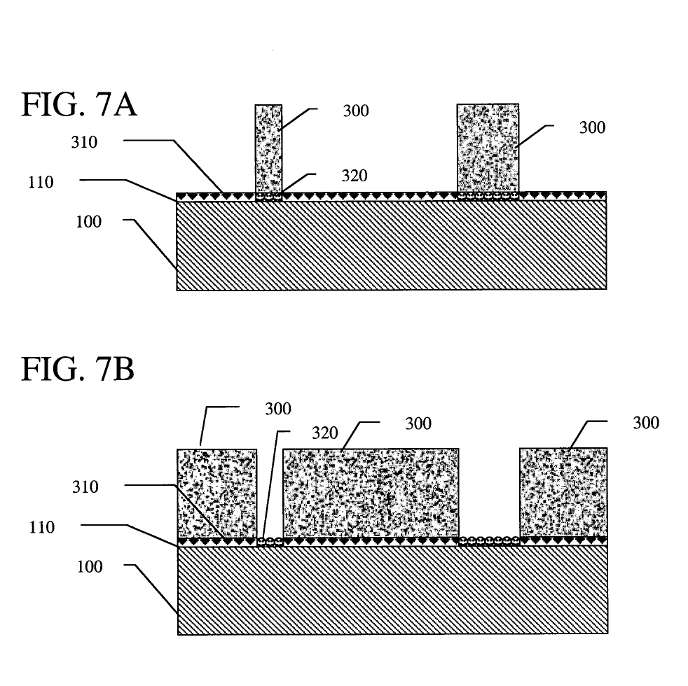

After removal of the stamp, the target adherent may be applied to the molecules coating the surface 110. In some embodiments, this simply involves exposing the surface coated with the first type of molecules 310 and the second type of molecules 320 with the target adherent. In embodiments in which the target adherent is a biological cell, the target adherent mixed with some growth medium is exposed to the surface coated with the first type of molecules 310 and the second type of molecules 320. The biological cell then preferentially grows (gets larger and/or multiplies) in regions coated with the type of molecule that has the adhesion promoting property and the biological cell avoids growth in the regions coated with the type of molecule having the adhesion inhibitory property. In FIGS. 7A-B, the target adherent 300 is shown attached to the surface 110 via the adhesion promoting type of molecule. In FIG. 7A, the second type of molecule 320 is the adhesion promoting type of molecule and the first type of molecule 310 is the adhesion inhibitory type of molecule. Therefore the target adherent 300 selectively adheres to the surface at the sites where the second type of molecule 320 was patterned, but not where the first type of molecule 310 was patterned. FIG. 7B shows the opposite situation; the first type of molecule 310 is the adhesion promoting type of molecule and the second type of molecule 320 is the adhesion inhibitory type of molecule. Therefore the target adherent 300 selectively adheres to the surface at the sites where the first type of molecule 310 was patterned, but not where the second type of molecule 320 was patterned. The target adherent 300 can attach to both the adhesion molecule and the substrate through physical and/or chemical interactions, as well as grow on the patterned surface 110 over time.

Alternate embodiments can achieve more robust patterning without relying solely on physical adsorption of the first and second molecules. These embodiments take advantage of covalent immobilization of peptides and molecules. In these embodiments, the above procedures are modified by treating the surface with a crosslinking molecule prior to stamping the surface with the stamp. Specific crosslinking molecules that have been found to be effective include glutaraldehyde (which bifunctionally links amino groups) and sulfo-GMBS (which bifunctionally links an amino group to a sulfur group). Amino groups are located off every amino acid in a protein, while an amino or sulfur group can be linked to a glass or plastic surface via a silanization reaction with aminopropyl triethoxysilane or mercaptopropyl triethoxy silane, respectively.

In the preferred embodiments, after the stamp is applied to the surface, it is not removed or realigned until the surface is patterned with both the adhesion promoting and adhesion inhibitory molecules. This can be a considerable advantage compared with approaches that require multiple stamping steps.

Another aspect of the invention provides a surface patterner for applying to a surface an adhesion inhibitory type of molecule adjacent to an adhesion promoting type of molecule in a manner consistent with the process steps disclosed above. The surface patterner comprises a stamp as shown in FIGS. 1A-B. The stamp 200 has raised 210 and recessed 220 portions, with lateral sides 212 on the raised portions 210. As shown in FIG. 2, the raised portions 210 should be capable of being inked with a first type of molecule 310 wherein the first type of molecule 310 has either an adhesion promoting property or an adhesion inhibitory property. As illustrated in FIGS. 5A-B, the surface patterner also has a means for flowing a second type of molecule 320 through selected openings 230 without realigning the stamp 200. The second type of molecule 320 should have an adhesion property complementary to that of the first type of molecule 310. A variety of means for flowing the second type of molecule 320 through the selected openings 230 can be used. The means can include a capillary pump or similar device to draw the second type of molecule 320 through the selected openings 230 by capillary action. However, alternative embodiments may employ a pump to provide a positive pressure to a solution of the second type of molecule 320 as it enters the selected openings 230 or a vacuum can be used to provide negative pressure to the solution of the second type of molecule 320 as it exits the selected openings 230. In yet other embodiments devices that induce a body force on the solution of the second type of molecule 320 can be used to induce it to flow through the selected openings 230.

The above description and drawings are only illustrative of preferred embodiments, and the present invention is not intended to be limited thereto. Any additional modification of the present invention that comes within the spirit and scope of the following claims is considered part of the present invention.

What is claimed is:

1. A method for patterning a surface to promote the patterned attachment of a target adherent, comprising the steps of:
providing a stamp having raised and recessed portions, the raised portions having lateral sides;
providing an adhesion inhibitory type of molecule and an adhesion promoting type of molecule, the adhesion inhibitory type of molecule having an adhesion property that inhibits the adhesion of the target adherent thereto, the adhesion promoting type of molecule having an adhesion property that promotes the adhesion of the target adherent thereto, the adhesion inhibitory type of molecule having an adhesion property complementary to the adhesion promoting type of molecule,
inking the raised portions of the stamp with a first type of molecule, the first type of molecule having either an adhesion inhibitory property or an adhesion promoting property;
stamping the surface with the stamp;
flowing a second type of molecule through selected openings, the selected openings being defined by selected portions of the surface, selected recessed portions of the stamp, and selected lateral sides of the raised portions of the stamp, wherein the second type of molecule has an adhesion property complementary to that of the first type of molecule;
removing the stamp.

2. The method for patterning a surface, according to claim 1, wherein the step of flowing a second type of molecule through selected openings is to be done without realigning the stamp.

3. The method for patterning a surface, according to claim 1, further comprising the step of:
flowing a cleaning solution through the selected openings, the flowing of the cleaning solution being done prior to the flowing of the second type of molecule.

4. The method for patterning a surface, according to claim 1, further comprising the steps of:
estimating if the amount of spreading of the first type of molecule to the selected portions of the surface exceeds an allowable tolerance;
flowing a cleaning solution through the selected openings if the amount of spreading of the first type of molecule to the selected portions of the surface is estimated to exceed the allowable tolerance, the flowing of the cleaning solution being done prior to the flowing of the second type of molecule.

5. The method for patterning a surface, according to claim 4, wherein the step of estimating if the amount of spreading of the first type of molecule to the selected portions of the surfaces exceeds an allowable tolerance involves determining the smallest distance along the surface of any of the selected openings.

6. The method for patterning a surface, according to claim 5, wherein if the smallest distance along the surface of any of the selected openings is less than 20 microns, the amount of spreading of the first type of molecule to the selected portions of the surfaces is estimated to exceed the allowable tolerance.

7. The method for patterning a surface, according to claim 1, further comprising the step of:
increasing the hydrophilicity of the stamp prior to the inking step.

8. The method for patterning a surface, according to claim 7, wherein the step of increasing the hydrophilicity of the stamp is accomplished by exposing the stamp to an oxygen plasma.

9. The method for patterning a surface, according to claim 1, further comprising the step of exposing the surface covered with first and second types of molecules to the target adherent.

10. The method for patterning a surface, according to claim 1, further comprising the step of selectively growing the target adherent to portions of the surface covered with adhesion promoting molecules.

11. The method for patterning a surface, according to claim 1, wherein the molecules having the adhesion inhibitory property are chosen from the group of: polyvinyl alcohol, polyethylene glycol, and bovine serum albumin.

12. The method for patterning a surface, according to claim 1, wherein the type of molecules having the adhesion promoting property are proteins.

13. The method for patterning a surface, according to claim 1, wherein the type of molecules having the adhesion promoting property are chosen from the group of: poly-D-lysine, laminin, and fibronectin.

14. The method for patterning a surface, according to claim 1, wherein the target adherent comprises a biological cell.

15. The method for patterning a surface, according to claim 1, further comprising the step of:
treating the surface with a crosslinking molecule prior to the step of stamping the surface.

16. The method for patterning a surface, according to claim 15, wherein the crosslinking molecule is gluaraldehyde.

17. The method for patterning a surface, according to claim 15, wherein the crosslinking molecule is sulfo-GMBS.

18. The method for patterning a surface, according to claim 1, wherein the surface is a glass.

19. The method for patterning a surface, according to claim 1, wherein the surface is a plastic.

20. The method for patterning a surface, according to claim 1, further comprising the step of:
drying the stamp after inking the raised portion of the stamp with a first type of molecule but prior to stamping the surface with the stamp.

21. The method for patterning a surface, according to claim 1, further comprising the step of:
flowing a cleaning solution through the selected openings, the flowing of the cleaning solution being done after the flowing of the second type of molecule.

22. The method for patterning a surface, according to claim 1, further comprising the step of:
drying the surface after flowing a second type of molecule through selected openings but prior to removing the stamp.

23. A surface patterner for applying to a surface an adhesion inhibitory type of molecule adjacent to an adhesion promoting type of molecule, the adhesion inhibitory type of molecule having an adhesion property that inhibits the adhesion of a target adherent thereto, the adhesion promoting type of molecule having an adhesion property that promotes the adhesion of the target adherent thereto, the adhesion inhibitory type of molecule having an adhesion property complementary to the adhesion promoting type of molecule, the surface patterner comprising:
a stamp having raised and recessed portions, the raised portions having lateral sides, the raised portions being capable of being inked with a first type of molecule, the first type of molecule having either an adhesion inhibitory property or an adhesion promoting property;
a means for flowing a second type of molecule through selected openings without realigning the stamp, the selected openings being defined by selected portions of the surface, selected recessed portions of the stamp, and selected lateral sides of the raised portions of the stamp, wherein the second type of molecule has an adhesion property complementary to that of the first type of molecule.
